(19) United States
(12) Patent Application Publication
(10) Pub. No.: US 2007/0182620 A1
(43) Pub. Date: Aug. 9, 2007

(54) Signal transformation apparatus and position recognition system having the same

(75) Inventors: Jung-han Choi, Yongin-si (KR); In-sang Song, Yongin-si (KR); Sang-wook Kwon, Yongin-si (KR); Dong-kyun Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/653,395

(22) Filed: Jan. 16, 2007

(30) Foreign Application Priority Data
Feb. 3, 2006 (KR) 10-2006-0010824

(51) Int. Cl. G01S 13/42

(52) U.S. Cl. 342/107; 342/195; 342/175; 342/83

(57) ABSTRACT

A signal transformation apparatus capable of performing stable transformation of a signal using a Mechanical switch includes a signal generator which generates a reserve pulse signal in response to an applied sync signal, a signal controller which outputs control signals to change and transform the reserve pulse signal to pulse signals having a predetermined pulse width, and a signal modulator which transforms the reserve pulse signal to the pulse signals having different pulse widths in response to the control signals. The signal modulator includes a switch bank in which a plurality of mechanical switches are connected in parallel, and a transmission line between nodes where the mechanical switches are formed.

### CROSS-REFERENCE TO RELATED APPLICATIONS

This application claims priority under 35 U.S.C. §119 (a) from Korean Patent Application No. 10-2006-10824 filed on Feb. 3, 2006, in the Korean Intellectual Property Office, the entire contents of which are incorporated herein by reference.

### BACKGROUND OF THE INVENTION

1. Field of the Invention

Apparatuses and systems consistent with the present invention relate to a signal transformation apparatus and a position recognition system having the same. More particularly, apparatuses and systems consistent with the present invention relate to a signal transformation apparatus capable of stable signal transformation using a mechanical switch without a separate signal compensation circuit, and a position recognition system having the signal transformation apparatus.

2. Description of the Related Art

Typically, a position recognition system, such as radar, measures a distance between the system and a target or a motion of the target, such as speed of the moving target, using a round trip time required for electromagnetic waves emitted from a signal transmitter at a certain wavelength to reflect from the target and return to a signal receiver, or using electromagnetic waves changed by the reflection at the target.

The position recognition system has a signal generating device for pulse generation so as to generate electromagnetic waves at a certain wavelength. However, when the signal generating device generates a pulse having a specific pulse width, it can acquire coordinates of the target position only in a set range with a set accuracy.

To overcome this, the signal generating device variably forms the pulse width to measure the coordinates of the target within an effective error range when the coordinates of the target position are measured in relation to the position recognition system.

FIG. 8 illustrates a related art signal generating device, and FIG. 9 illustrates a simplified circuit diagram of a related art signal modulator 20 of FIG. 8.

Referring first to FIG. 8, the related art signal generating device 1 includes a signal generator 10, a signal modulator 20, a signal controller 30, and a signal compensator 40.

The signal generator 10 generates a step-like reserve pulse signal O_PS having a certain shape, such as rising transition interval, in response to an incoming signal when a sync signal, that is, a trigger signal is input. The reserve pulse signal O_PS is defined as a signal having unspecified falling edge timing and pulse width, rather than a pulse signal with a rising edge, a falling edge, and a predetermined pulse width.

The signal modulator 20 outputs a first primitive pulse signal P_PS1 or a second primitive pulse signal P_{‘3}PS2 by phase-inverting the reserve pulse signal O_PS, which is output from the signal generator 10, by 180 degrees based on a control signal CNT output from the signal controller 20 and adjusting an output delay time.

The signal modulator 20 includes a switch bank which is a plurality of switch elements connected in parallel as shown in FIG. 9. Note that the switch bank selectively activates only one switch element in response to a control signal CNT1, . . . , CNTn.

The signal controller 30 outputs the control signals CNT to convert the reserve pulse signal O_PS to the primitive pulse signals P_PS1 and P_PS2 with the certain pulse width and applies them to the switch bank of the signal modulator 20.

For instance, when the signal controller 30 outputs a control signal CNT of logical combination “0 0 . . . 1”, only the n-th switch element SWn is activated. When a control signal CNT of logical combination “0 1 . . . 0” is output, only the second switch element SW2 is activated.

The reserve pulse signal O_PS, which is output from the signal generator 10, is phase-inverted by 180 degrees via the activated switch element SW. The reserve pulse signal O_PS has the time difference between the input and the output due to the position difference from nodes N5 and N6 where the switch elements SW branch off, that is, due to transmission lines lₗ through lₙ having different lengths. The reserve pulse signal O_PS is transformed to the first and second primitive pulse signals P_PS1 and P_PS2 by the pulse width that is determined in proportion to the inverted phase, and the time difference between the input and the output.

The reserve pulse signal O_PS and the inverted reserve pulse signal, which passed through the phase inversion by 180 degrees, are synthesized to generate one pulse signal. As the generated pulse signal is delayed and then output due to the transmission lines lₗ through lₙ, the pulse width is determined. Accordingly, it is transformed to the first or second primitive pulse signal P_PS1 or P_PS2 with the pulse width and output through the branched nodes N5 and N6.

The signal compensator 40 compensates modulation error according to the characteristics of the switch elements SW1 through SWn of the switch bank in the signal modulator 20 when the reserve pulse signal O_PS is modulated to the first or second primitive pulse signal P_PS1 or P_PS2. Thus, the first or second primitive pulse signal P_PS1 or P_PS2 is output as the first or second pulse signal PS1 or PS2 which passed through the modulation error compensation.

The switch of the switch bank in the signal modulator 20 generally adapts a metal-oxide semiconductor field effect transistor (MOSFET) or a PIN (positive, intrinsic, negative) diode for the sake of integration, high-speed switching operation, long life, and low cost.

As mentioned above, if the switch in the signal modulator 20 employs the semiconductor switch such as MOSFET or PIN diode, it is suitable for the narrow-band frequency.

By contrast when a MOSFET or a PIN diode is applied to the broadband frequency, insertion loss increases because of the element characteristics relating to composite components of resistance, inductance and capacitance of the semiconductor switch, and the electrical isolation is degraded. Therefore, the modulation error occurs when the pulse width is varied.

To address the above disadvantages, typically, each switch of the semiconductor switch needs to further include a broadband matching network (BMN) 21, and a signal compensator 40 which compensates the modulation error of the first and second primitive pulse signals P_PS1 and P_PS2 modulated.

Disadvantageously, as each switch in the signal modulator 20 further includes the BMN 21 and the signal compensator 40, the manufacturing cost of the signal transformation apparatus increases, which is contrary to the high integration and the miniaturization of the product.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Aspects of the present invention provide a signal transformation apparatus for stable signal modulation without a separate signal compensation circuit.

Another aspect of the present invention provides a position recognition system having the signal transformation apparatus.

According to an aspect of the present invention, there is provided a signal transformation apparatus including a signal generator, a signal controller, and a signal modulator. The signal generator generates a reserve pulse signal in response to an applied sync signal. The signal controller outputs control signals to change and transform the reserve pulse signal to pulse signals having a predetermined pulse width. The signal modulator transforms the reserve pulse signal to the pulse signals having different pulse widths in response to the control signals.

The signal modulator includes a switch bank in which a plurality of mechanical switches are connected in parallel, and a transmission line between nodes where the mechanical switches are formed.

The switch bank of the signal modulator may include a micro-electro-mechanical system (MEMS) switch.

The switch bank of the signal modulator may include a single pole single throw (SPST) switch. The switch bank of the signal modulator may include a single pole double throw (SPDP) switch.

The signal modulator may generate a reserve pulse signal which is phase-inverted by 180 degrees when the reserve pulse signal passes through the mechanical switch which is activated in response to the control signals and the transmission line, and generate one pulse signal by synthesizing the reserve pulse signal and the inverted reserve pulse signal.

The signal modulator may vary a pulse width of the pulse signal which is generated using a time difference between the input and the output of the reserve pulse signal, the time difference occurring by a difference of the mechanical switch activated in response to the control signals and a length of the transmission line.

The signal generator may output the reserve pulse signal which is step-like with a rising transition interval.

The signal controller may set the pulse width to a preset default value at an initial operation.

According to another aspect of the present invention, a position recognition system includes a transmission part, a reception part, a signal transformation part, and a position determination part. The transmission unit outputs a first transmission signal and a second transmission signal with a predetermined frequency range. The reception unit receives a first reception signal and a second reception signal that are reflected by a target, respectively, after the first and second transmission signals reach the target. The signal transformation unit generates a reserve pulse signal, transforms the reserve pulse signal to a first pulse signal to output the first transmission signal by varying the reserve pulse signal, and transforms to second pulse signals to output the second transmission signal by varying the reserve pulse signal based on the first reception signal. The position determination unit determines first position information of the target based on the first transmission signal and the first reception signal, and determines second position information of the target based on the second transmission signal and the second reception signal.

The signal transformation unit generates control signals to vary the reserve pulse signal based on the first position information, and comprises a switch bank having mechanical switches which are selectively activated in response to the control signals and which generate the second pulse signals, and a transmission line between nodes where the mechanical switches are formed.

The switch bank of the signal modulator may include a micro-electro-mechanical system (MEMS) switch.

The signal transformation unit may include a signal generator which generates a reserve pulse signal in response to an applied sync signal; a signal controller which outputs control signals to change and transform the reserve pulse signal to the first and second pulse signals; and a signal modulator which comprises the switch bank and the transmission line, and transforms the reserve pulse signal to the first and second pulse signals in response to the control signals.

The signal transformation unit may generate a reserve pulse signal which is phase-inverted by 180 degrees when the reserve pulse signal passes through the mechanical switch which is activated in response to the control signals and the transmission line, and generate one pulse signal by synthesizing the reserve pulse signal and the inverted reserve pulse signal.

The signal transformation unit may vary a pulse width of the pulse signal which is generated using a time difference between the input and the output of the reserve pulse signal, the time difference occurring by a difference of the mechanical switch activated in response to the control signals and a length of the transmission line.

A pulse width of the first pulse signal may be determined by a control signal which is set to a default value.

### BRIEF DESCRIPTION OF THE DRAWINGS

Aspects of the present invention will become more apparent and more readily appreciated from the following description of exemplary embodiments thereof, with reference to the accompanying drawings, in which:

FIG. 1 is a simplified block diagram of a position recognition system according to an exemplary embodiment of the present invention;

FIG. 2 is a simplified block diagram of the signal transformation unit of FIG. 1;

FIG. 3 is a simplified circuit diagram of the signal modulator of FIG. 2;

FIG. 4 is a diagram illustrating an output pulse of the signal modulator of FIG. 3;

FIG. 5 is a plane view of a switch element of FIG. 3;

FIG. 6 is an enlarged perspective view of the area A of FIG. 5;

FIG. 7 is a graph illustrating the switching characteristic of the switch element of FIG. 4;

FIG. 8 is a simplified block diagram of a related art signal generating apparatus; and

FIG. 9 is a simplified circuit diagram of the related art signal modulator of FIG. 8.

### DETAILED DESCRIPTION OF THE EXEMPLARY EMBODIMENTS

Certain exemplary embodiments of the present invention will now be described in greater detail with reference to the accompanying drawings.

In the following description, the same drawing reference numerals are used to refer to the same elements, even in different drawings. The matters defined in the following description, such as detailed construction and element descriptions, are provided as examples to assist in a comprehensive understanding of the invention. Also, well-known functions or constructions are not described in detail, since they would obscure the invention in unnecessary detail.

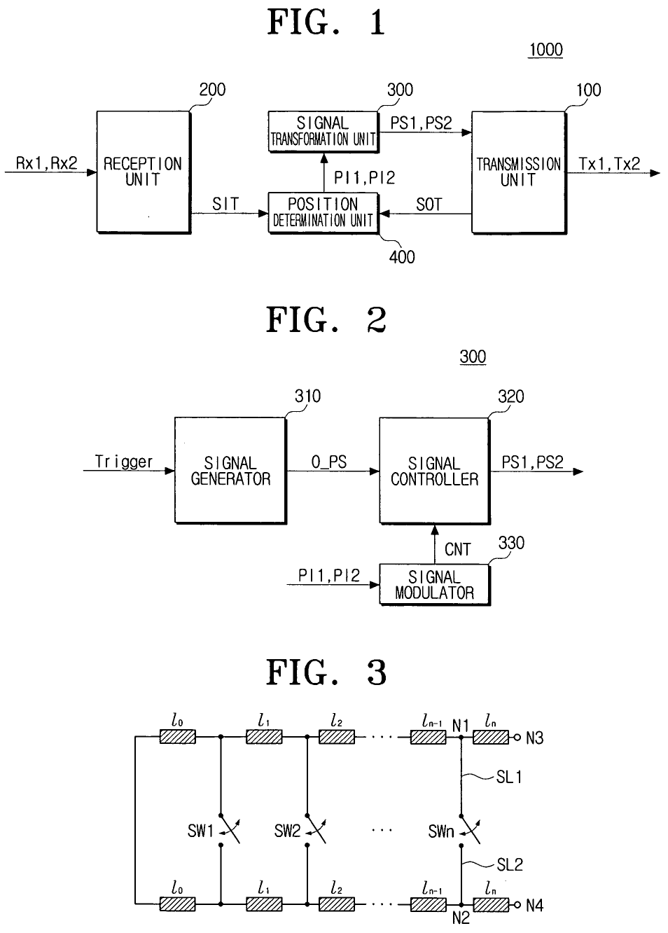

FIG. 1 is a simplified block diagram of a position recognition system according to an exemplary embodiment of the present invention.

Referring first to FIG. 1, the position recognition system 1000 according to an exemplary embodiment of the present invention includes a transmission unit 100, a reception unit 200, a signal transformation unit 300, and a position determination unit 400.

The transmission unit 100 receives a first pulse signal PS1 or a second pulse signal PS2 from the signal transformation unit 300 and outputs a first transmission signal Tx1 or a second transmission signal Tx2 in a predetermined frequency range in accordance to the first or second pulse signal PS1 or PS2. Note that the first and second transmission signals Tx1 and Tx2 are different from each other in the frequency range.

The reception unit 200 receives first and second reception signals Rx1 and Rx2 that are reflected by a target after the first and second transmission signals Tx1 and Tx2 reach the target.

The signal transformation unit 300 generates a reserve pulse signal O_PS in response to a sync signal.

Herein, the reserve pulse signal O_PS is defined as a signal having unspecified falling edge timing and pulse width, rather than a pulse signal having a rising edge, a falling edge, and a pulse width.

The signal transformation unit 300 generates an inverted reserve pulse signal (not shown) by phase-inverting the reserve pulse signal O_PS by 180 degrees, and generates one pulse signal by synthesizing the reserve pulse signal O_PS and the inverted reserve pulse signal. The signal transformation unit 300 generates first and second pulse signals to output the first and second transmission signals Tx1 and Tx2 by determining a pulse width of the pulse signal that is produced by synthesizing the reserve pulse signal O_PS and the inverted reserve pulse signal. The second pulse signal is generated and output by phase-inverting the reserve pulse signal by 180 degrees based on the first reception signal Rx1 and determining its pulse width.

The signal transformation unit 300 generates control signals which vary the reserve pulse signal O_PS based on the time difference between the input and the output of the first reception signal Rx1 and the first transmission signal Tx1, or based on first position information PI1 of the target which is estimated according to the frequency change. The signal transformation unit 300 includes a switch bank having mechanical switches which are selectively activated in response to the generated control signal, for example, micro-electro-mechanical system (MEMS) switches, and a transmission line between nodes where the switches of the switch bank are formed. The signal transformation unit 300 will be further explained in reference to FIG. 2 through FIG. 7.

The position determination unit 400 determines the first position information PI1 of the target based on the first transmission signal Tx1 and the first reception signal Rx1. Note that it is hard to acquire accurate position information, but coordinates of the target position can be determined merely in a certain range and with a certain accuracy since the first transmission signal Tx1 is output as a preset default value when the position recognition system 1000 initially operates.

Hence, the position determination unit 400 applies the first position information PI1 to the signal transformation unit 300 to determine the accurate position information of the target. The signal transformation unit 300 outputs a second pulse signal PS2 by changing the reserve pulse signal based on the first position information PI1.

The position determination unit 400 can receive the output timing signal SOT of the first transmission signal Tx1 and the input timing signal SIT of the first reception signal Rx1 from the transmission unit 100 and the reception unit 200, respectively, so as to measure the distance between the position recognition system 1000 and the target. To measure a speed of the target, a frequency range of the first transmission signal Tx1 and a frequency range of the first reception signal Rx1 are received and compared. As a result, the position determination unit 400 can determine the first position information PI1 which is the approximate target information.

In the same way, the position determination unit 400 measures the distance between the position recognition system 1000 and the target or the speed of the moving target by determining second position information PI2 of the target based on the second transmission signal Tx2 and the second reception signal Rx2.

It is possible to implement accurate position recognition system by repeating the above operations until the coordinate or the moving speed of the target is acquired within the range of the desired accuracy.

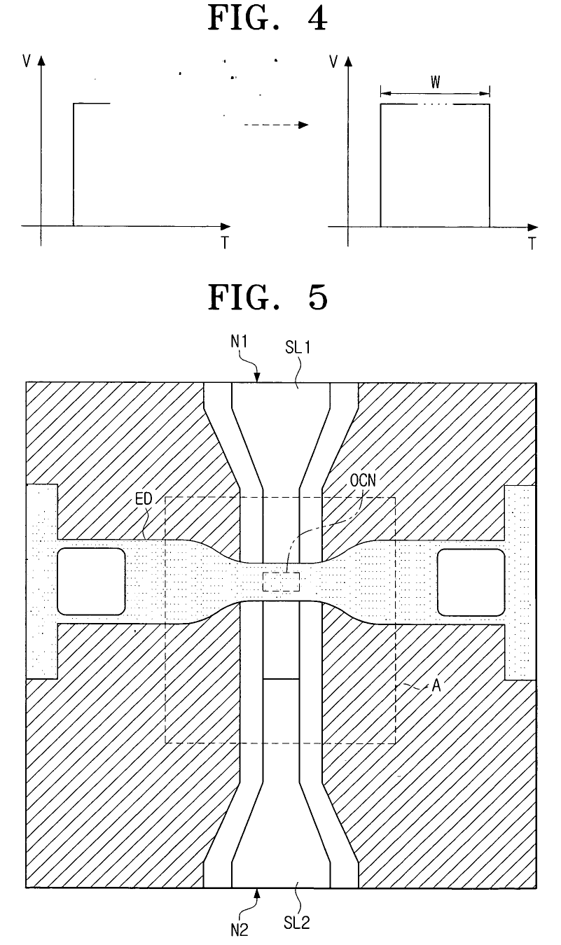

FIG. 2 is a simplified block diagram of the signal transformation unit 300 of FIG. 1, FIG. 3 is a simplified circuit diagram of a signal modulator 330 of FIG. 2, and FIG. 4 is a diagram for illustrating the output pulse of the signal modulator 330 of FIG. 3.

Referring to FIG. 2, according to an exemplary embodiment of the present invention, the signal transformation unit 300 includes a signal generator 310, a signal controller 320, and a signal modulator 330.

The signal generator 310 receives a sync signal, that is, a trigger signal when it operates and generates the step-like reserve pulse signal O_PS having the rising transition interval as shown in FIG. 4, to determine the position information of the target.

The signal controller 320 outputs control signals CNT to generate the first and second pulse signals PS1 and PS2 with a predetermined pulse width by varying the reserve pulse signal O_PS. For instance, when the signal controller 320 initially operates, it outputs control signals to determine the pulse width of the second pulse signal PS2 in response to the control signal which is stored as a default value to generate the first pulse signal PS1 with a predetermined pulse width or the first position information PI1 which is output from the position determination unit 400 as shown in FIG. 1.

The signal modulator 330 receives the reserve pulse signal O_PS output from the signal generator 310, changes the reserve pulse signal O_PS in response to the control signals CNT, and outputs the second pulse signal PS2, which is to calculate the second position information PI2 of the target, based on the first pulse signal PS1 that is to calculate the first position information PI1 of the target when it operates, or the first position information PI1.

The above operations are repeated until the coordinate or the moving speed of the target is acquired within the range of the desired accuracy.

The signal transformation unit 300 as constructed above is described in more detail in reference to FIG. 1 through FIG. 4.

As the position recognition system 1000 operates, to determine the first position information PI1 of the target with respect to the position recognition system 1000, the signal controller 320 controls the signal modulator 330 to change the reserve pulse signal O_PS output from the signal generator 310 to the first pulse signal PS1 having a preset pulse width.

Accordingly, the signal modulator 330 outputs the first pulse signal PS1 with the preset pulse width in response to the control signal stored as the default value.

The first pulse signal PS1 is output to the target as the first transmission signal Tx1 having wavelengths in the frequency range corresponding to the first pulse signal PS1 via the transmission unit 100.

The first transmission signal Tx1 output to the target is reflected by the target and input to the reception unit 200 as the first reception signal Rx1.

The position determination unit 400 roughly calculates the first position information PI1 of the target by determining the time difference between the input and the output or the signal change with respect to the first transmission signal Tx1 and the first reception signal Rx1, and provides the first position information PI1 to the signal controller 320.

Accordingly, the signal controller 320 controls the signal modulator 330 to output the second pulse signal PS2 by changing the reserve pulse signal O_PS.

To calculate the second position information PS2 which is the accurate position information of the target, the second transmission signal Tx2 needs to be output with the long pulse width when the target is located in the distance. When the target is located at a short distance, the second transmission signal Tx2 needs to be output with the short pulse width. To this end, the pulse width of the second pulse signal PS2 is determined by changing the reserve pulse signal O_PS.

Hence, the signal transformation unit 300 outputs the second pulse signal PS2 to output the second transmission signal Tx2 based on the first position information PI1 of the target which is located statically or dynamically. The second pulse signal PS2 is output to the target via the transmission unit 100 as the second transmission signal Tx2 in the frequency range corresponding to the second pulse signal PS2.

The position determination unit 400 calculates the second position information PI2 which is the accurate information of the target, based on the second transmission signal Tx2 and the second reception signal Rx2 which is reflected from the second transmission signal Tx2.

While the position recognition system 1000 is driven, the second position information PI2 being determined is provided to the signal transformation unit 300 through the endless loop so that the position recognition system 1000 realizes the position information of the target in succession.

The signal modulator 330 includes a switch bank having a plurality of switch elements SW1 through SWn, and transmission lines with lengths iₗ through lₙ between nodes where the switch elements SW1 through SWn are formed, as illustrated in FIG. 3.

In the switch bank according to the exemplary embodiment of the present invention, the switch element employs a mechanical switch. For instance, the switch element may be, but is not limited to, a MEMS switch.

When the control signals CNT output from the signal controller 320 are output as the n-bit logical combination “0 0 . . . 1”, only the n-th switch element SWn of the switch bank is activated. When the control signal CNT is output as the logical combination “1 0 . . . 0”, only the first switch element SW1 of the switch bank is activated.

As the reserve pulse signal O_PS passes through the activated switch element SW and the transmission line, a reserve pulse signal which is phase-inverted by 180 degrees is generated. The reserve pulse signal O_PS and the inverted reserve pulse signal are synthesized to generate one pulse signal.

The generated pulse signal is delayed and output by the activated switch element SW and the length of the transmission line to the activated switch element SW, that is, by the activated switch element and the length between nodes N3 and N4 where the switch bank branches off.

In proportion to the delayed output time difference, that is, when one switch element SW is activated in the direction from the n-th switch element SWn to the first switch element SW1, the pulse width w of the generated pulse signal is set to an increasing value.

For example, the length (l₀+lₗ+. . . +lₙ) of the transmission line formed when the first switch element SW1 is activated is different from the length (l₁+l₂ . . . +lₙ) of the transmission line formed when the second switch element SW2 by the length (l₀) of the transmission line. The generated pulse signal has the delayed output time difference proportional to the length (l₀) of the transmission line through which it passes.

Thus, the generated pulse signal is delayed by the time that it passes through the length (l₀) of the transmission line and then output. The pulse width w of the pulse signal is greater when the first switch element SW1 is activated, compared to the case when the second switch element SW2 is activated.

In summary, as the reserve pulse signal O_PS passes through the activated switch element SW and the transmission line, it is synthesized with the reserve pulse signal which is phase-inverted by 180 degrees and transformed into one pulse signal. The generated pulse signal is output as the second pulse signal PS2 after its pulse width w is changed by the delayed output time due to the activated switch element SW and the length of the transmission line to the activated switch element SW.

The first pulse signal PS1 may be formed to activate any one of the first through n-th switch elements and to have a predetermined pulse width. The control signal CNT for generating the first pulse signal PS1 may be generated as a default value with an arbitrary logical combination.

The switch bank of the signal modulator 330 is formed as a shunt along the transmission line between the signal generator 310 and the transmission unit 100.

The switch element in the signal modulator 330 is further explained below.

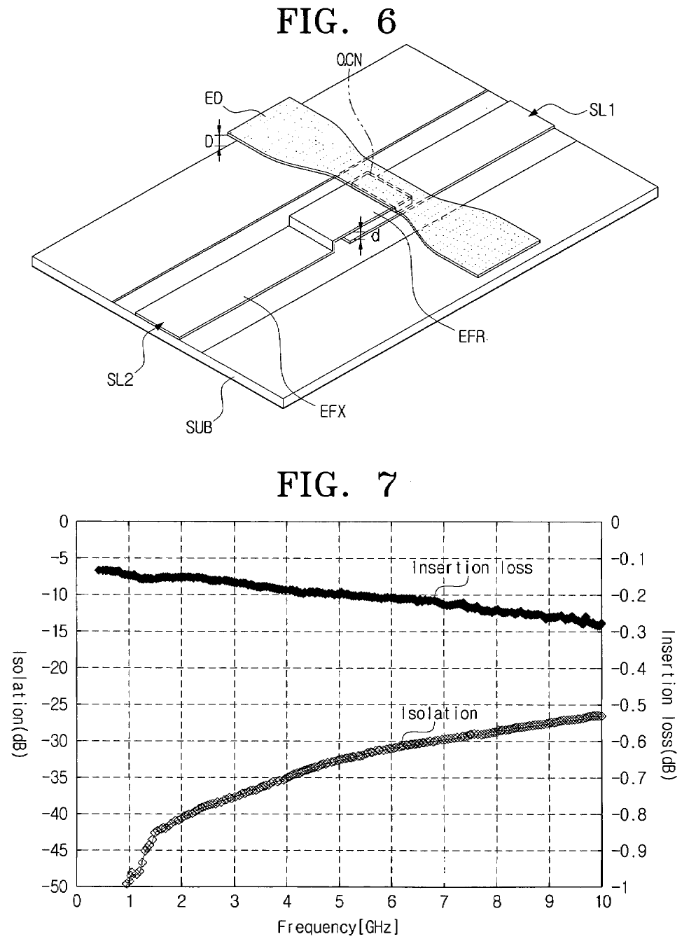

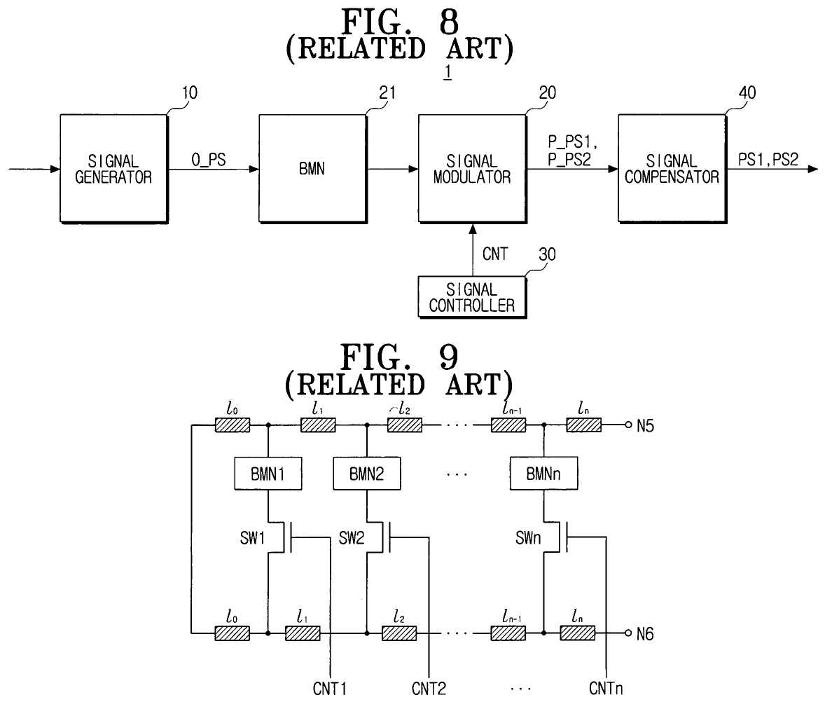

FIG. 5 is a plane view of the switch element of FIG. 3, FIG. 6 is an enlarged perspective view of the area A of FIG. 5, and FIG. 7 is a graph for illustrating the switching characteristic of the switch element of FIG. 5.

Referring to FIGS. 2 through 6, according to an exemplary embodiment of the present invention, the signal modulator 330 is implemented using a switch bank having a MEMS switch.

In the exemplary embodiment of the present invention, the MEMS switch SW includes a driving electrode ED and a contact member OCN.

The driving electrode ED extends on both sides facing the first signal line SL1 separated from the first node N1 and the second signal line SL2 separated from the second node N2. The driving electrode ED is spaced from the substrate SUB by a certain distance D. The driving electrode ED is formed to cover one end of the first signal line SL1 and the second signal line SL2, respectively. The control signal CNT from the signal controller 320 is applied to the driving electrode ED. The control signal CNT is applied as a voltage of potential level corresponding to the logical value “0” or “1”.

The first signal line SL1 is formed as a fixed signal line in close contact with the substrate SUB. The second signal line SL2 consists of a fixed end EFX which is formed on the substrate SUB in proximity of the second node N2, and a free end EFR which is spaced from the first signal line SL1 by a certain distance d in the proximity of the first node N1. The contact member OCN is formed under the free end EFR, facing one end of the first signal line SL1.

When the control signal CNT, that is, the potential level corresponding to the logical value “1” is applied from the signal controller 320, an electric field is generated between the potential of the control signal CNT and the substrate voltage, that is, the ground voltage GND. Accordingly, the contact member OCN moves toward the substrate because the electrostatic attraction occurs between the contact member OCN and the driving electrode ED.

Hence, the free end EFR of the second signal line SL2 where the contact member OCN is formed moves toward the substrate SUB so that the first signal line SL1 and the second signal line SL2 electrically contact.

As the first signal line SL1 and the second signal line SL2 make the electrical contact, the transmission line of the reserve pulse signal O_PS output from the signal generator 310 is formed.

When the reserve pulse signal O_PS passes through the activated switch element SW and the transmission line, it is phase-inverted by 180 degrees and delayed to generate the inverted reserve pulse signal. The reserve pulse signal O_PS and the inverted reserve pulse signal are thus synthesized to generate one pulse signal. The pulse width of the generated pulse signal is determined by the distance between the nodes N3 and N4 from which the activated switch element SW and the switch bank are separated, and the activated switch element SW, that is, the difference of the transmission line length, and the reserve pulse signal O_PS is transformed and output as the first and second pulse signals PS1 and PS2.

When the signal modulator 330 is a mechanical switch such as a MEMS switch, as in the exemplary embodiment of the present invention, it may have the signal characteristic as shown in FIG. 7.

Referring now to FIG. 7, as the signal modulator 330 employs the MEMS switch, the insertion loss decreases as it proceeds from low frequency to high frequency and the isolation increases as it proceeds from low frequency to high frequency.

In case of an ideal switch element, the insertion loss is 0 dB and the isolation is −∞ regardless of the frequency. Herein, the insertion loss is a value in dB of return loss derived from a reflection coefficient of an S transfer matrix with respect to the ON and OFF states all of the switch element in the 2-port network.

However, as exemplified in FIGS. 8 and 9, the semiconductor switch such as MOSFET or PIN diode suffers degradation of the insertion loss and isolation because of the composite components of resistance, inductance, and capacitance of the semiconductor switch.

Thus, when the switch bank of the signal modulator 330 is constructed using the semiconductor switch, it is necessary to further include a BMN 21 and a signal compensator 40 to compensate the degradation.

Exemplary embodiments of the present invention implement the switch element using the MEMS switch to achieve the isolation and the insertion loss of the signal modulator 330 which do not exceed the permissible ranges regardless of the frequency change.

This implies that it is possible to implement a switch having equivalent or better switch operation without the BMN and the signal compensator 40 that are requisite for the semiconductor switch.

The MEMS switch described so far is an example of MEMS switch. It should be understood the switch bank of the signal modulator 330 may be implemented using various MEMS switches.

Although the MEMS switch is the single pole single throw (SPST) switch in the exemplary embodiment of the present invention, various switches, for example, but not limited to, single pole double throw (SPDP) switches may be used.

As set forth above, the signal transformation apparatus modulates and outputs the pulse width using mechanical switches. Therefore, it is possible to avoid the degradation of the insertion loss and the isolation that occur when semiconductor switches are used, and to achieve stable signal modulation.

The miniaturization and the high integration of the signal transformation apparatus can be realized by omitting the signal compensator and the BMN that are requisite for the prevention of the degradation of the insertion loss and the isolation due to the composite components of resistance, inductance, and capacitance when the semiconductor switch is used.

Therefore, the miniaturization and the high integration of the position recognition system can be realized and the manufacturing cost can be reduced.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A signal transformation apparatus comprising:
a signal generator which generates a reserve pulse signal in response to an applied sync signal;
a signal controller which outputs control signals and transforms the reserve pulse signal into pulse signals having a predetermined pulse width; and
a signal modulator which transforms the reserve pulse signal into the pulse signals having different pulse widths in response to the control signals,
wherein the signal modulator comprises:
a switch bank in which a plurality of mechanical switches are connected in parallel, and
a transmission line between nodes where the mechanical switches are formed.

2. The signal transformation apparatus as in claim 1, wherein the switch bank of the signal modulator includes a micro-electro-mechanical system (MEMS) switch.

3. The signal transformation apparatus as in claim 1, wherein the switch bank of the signal modulator includes a single pole single throw (SPST) switch.

4. The signal transformation apparatus as in claim 1, wherein the switch bank of the signal modulator includes a single pole double throw (SPDP) switch.

5. The signal transformation apparatus as in claim 1, wherein the signal modulator generates a reserve pulse signal which is phase-inverted by 180 degrees when the reserve pulse signal passes through the mechanical switch which is activated in response to the control signals and the transmission line, and generates one pulse signal by synthesizing the reserve pulse signal and the inverted reserve pulse signal.

6. The signal transformation apparatus as in claim 5, wherein the signal modulator varies a pulse width of the pulse signal which is generated using a time difference between an input time and an output time of the reserve pulse signal, the time difference resulting from a difference of the mechanical switch activated in response to the control signals and a length of the transmission line.

7. The signal transformation apparatus as in claim 1, wherein the signal generator outputs the reserve pulse signal which is step-like with a rising transition interval.

8. The signal transformation apparatus as in claim 1, wherein the signal controller sets the pulse width to a default value at an initial operation.

9. A position recognition system comprising:
a transmission unit which outputs a first transmission signal and a second transmission signal with a predetermined frequency range;
a reception unit which receives a first reception signal and a second reception signal that are reflected by a target after the first and second transmission signals, respectively, reach the target;
a signal transformation unit which generates a reserve pulse signal, transforms the reserve pulse signal into a first pulse signal to output the first transmission signal by varying the reserve pulse signal, and transforms the reserve pulse signal into second pulse signals to output the second transmission signal by varying the reserve pulse signal based on the first reception signal; and
a position determination unit which determines first position information of the target based on the first transmission signal and the first reception signal, and determines second position information of the target based on the second transmission signal and the second reception signal,
wherein the signal transformation unit generates control signals to vary the reserve pulse signal based on the first position information, and comprises a switch bank having mechanical switches which are selectively activated in response to the control signals and generate the second pulse signals, and a transmission line between nodes where the mechanical switches are formed.

10. The position recognition system as in claim 9, wherein the switch bank of the signal modulator includes a micro-electro-mechanical system (MEMS) switch.

11. The position recognition system as in claim 9, wherein the signal transformation unit comprises:
a signal generator which generates a reserve pulse signal in response to an applied sync signal;
a signal controller which outputs control signals and transforms the reserve pulse signal into the first and second pulse signals; and
a signal modulator which comprises the switch bank and the transmission line, and transforms the reserve pulse signal into the first and second pulse signals in response to the control signals.

12. The position recognition system as in claim 9, wherein the signal transformation unit generates a reserve pulse signal which is phase-inverted by 180 degrees when the reserve pulse signal passes through the mechanical switch which is activated in response to the control signals and the transmission line, and generates one pulse signal by synthesizing the reserve pulse signal and the inverted reserve pulse signal.

13. The position recognition system as in claim 12, wherein the signal transformation unit varies a pulse width of the pulse signal which is generated using a time difference between an input time and an output time of the reserve pulse signal, the time difference resulting from a difference of the mechanical switch activated in response to the control signals and a length of the transmission line.

14. The position recognition system as in claim 9, wherein a pulse width of the first pulse signal is determined by a control signal which is set to a default value.
